(19) United States
(12) Patent Application Publication
(10) Pub. No.: US 2020/0297465 A1
(43) Pub. Date: Sep. 24, 2020

(54) TOOTHPICK FOR ORAL HYGIENE

(71) Applicant: Rodrigo BARRIOS MONDRAGON, Col. Condesa, Ciudad de México (MX)

(72) Inventor: Rodrigo BARRIOS MONDRAGON, Col. Condesa, Ciudad de México (MX)

(21) Appl. No.: 16/089,105

(22) PCT Filed: Nov. 29, 2016
(86) PCT No.: PCT/MX2016/000122

§ 371 Date: Sep. 27, 2018

(30) Foreign Application Priority Data
Mar. 31, 2016 (MX) MX/U/2016/000130

(51) Int. Cl. A61C 15/02

(52) U.S. Cl. CPC A61C 15/02; A61C 2204/00

(57) ABSTRACT

The present invention relates to a toothpick for oral hygiene that has ultra-slim dimensions that allow deep, efficient and effective cleaning of the interproximal space, to remove the majority of food remains. The toothpick is formed from any type of flexible material and the shape thereof is formed by straight or curved lines or combinations thereof limited to the dimensions of the toothpick (length by width by thickness), providing properties of flexibility, ultra-lightness and ultra-fineness. The invention is mainly characterised in that the end sections of the toothpick are formed by straight or curved lines or combinations thereof, which narrow progressively, the ends thereof forming symmetrical or asymmetrical, regular, irregular, organic, hand-drawn or accidental figures with a diameter, axis, base, height, straight side, perpendicularity, cross-section or oblique section of less than 0.75 mm with respect to the width of the end section of the toothpick. The invention is further characterised in that the end section of the toothpick can extend longitudinally between 0.1 and 20 mm to the end of the end section, with respect to the length of the toothpick.

### FIELD OF THE INVENTION

The present invention is related to the oral health and hygiene industry, more specifically with a toothpick for oral hygiene composed by any flexible material where its ends are formed from two straight lines, curved lines or a combination of both.

### INVENTION BACKGROUND

Nowadays there are traditional wooden or plastic toothpicks as well as specialized orthodontic instruments that clean between the teeth.

These wooden or plastic sticks have normally a rounded or squared section, about 60 mm long and about 2 mm thick in their body, with tips that are sharpened at their ends.

However, due to their dimensions they cannot reach between teeth or molars efficiently, therefore they do not remove food remains correctly.

The U.S. Pat. No. 6,158,444 “Interdental cleaner and manufacturing process” refers to an interdental cleaner formed by an elongated element of plastic material covered in certain areas of its surface by at least one plastic support that is softer than the first plastic material. To manufacture the interdental cleaner, the second plastic material is injected into the carrier's first plastic material. However, it does not have the dimensions and geometric shape required to allow deep, efficient and effective cleaning of the interproximal space in order to remove most food remains.

The Mexican patent application MX/a/2013/002641 “Specific-function flavored toothpicks” refers to a flavored toothpick and to a method of preparation of the product exhibiting improved ability to deliver flavor and additives to the user among other advantages. The toothpick can be prepared by pre-treating the wood substrate to increase porosity and decrease hardness. The toothpick is then immersed in a solution containing an additive, a masking agent and a sweetening agent, where the toothpick absorbs the solution. Alternatively the toothpick can be placed with the solution in a sealed chamber under vacuum pressure to infuse the toothpick with the additive solution and any desired flavor. However, it does not have the dimensions or geometric shapes that allow the deep, efficient and effective cleaning of the interproximal space in order to remove most food remains.

The U.S. Pat. No. 5,927,299 “Hygienic tooth cleansing device” refers to a device for dental hygiene and cleaning rubber formed by an elongated metal or filament to be adapted between the adjacent teeth to remove waste. However, it does not have the dimensions or geometric shapes that allow the deep, efficient and effective cleaning of the interproximal space in order to remove most food remains.

The Mexican utility model 2.522 “Flexible flat toothpick” which consists of a substantially rectangular thin sheet preferably made of a plastics sheet, although it may be made of another flexible material. In addition to flexible the material must not be toxic, brittle or prone to splintering. However, it does not have the dimensions or geometric shapes that allow the deep efficient and effective cleaning of the interproximal space in order to remove most food remains.

### Invention's Goals

One of the goals of this invention is to provide a toothpick that allows the deep efficient and effective cleaning of the interdental space in order to remove most food remains.

Another goal is to provide a toothpick which geometry is basically formed by straight lines, curved lines or combinations of both, limited to their dimensions (length by width by thickness), to provide it with flexibility properties, ultra-lightness and ultra-fineness.

Yet another goal is to provide a toothpick which final sections are formed by straight lines, curved lines or a combination of both, that narrow or sharpen progressively, whose ends form shapes that can be symmetrical or asymmetrical, regular or irregular, organic, hand drawn or accidental and whose diameter, axis, base, height, straight side, perpendicularity, cross section or oblique cut is less than 0.75 mm regarding the width of the toothpick's final section and that the toothpick's final section can extend longitudinally between 0.1 and 20 mm towards the end of the toothpick's final section, regarding the toothpick's length.

And all those advantages and goals that will become evident with the reading of the present description and joint images that has an integral part thereof are appended for illustrative but not limitative purposes, to the present description.

### BRIEF DESCRIPTION OF THE INVENTION

The present invention is related to a toothpick for oral hygiene whose ultra-thin dimensions allow deep, efficient and effective cleaning of the interproximal space in order to remove most food remains. The toothpick can be made of any type of flexible material and its geometry is formed by straight lines, curved lines or a combination of both, it's dimensions limited (length by width by thickness), which provides flexibility properties, ultra-lightness and ultra-fineness.

The toothpick for oral hygiene is formed by a single piece of elongated flexible material with a length that can be chosen, but not limited to, between 40 and 80 mm; the width that can be chosen, but not limited to, between 0.05 and 10 mm which could vary along the toothpick; a thickness that can be chosen, but not limited to, between 0.1 and 2 mm, thickness can vary along the toothpick.

The main characteristic of the toothpick which is the present invention is that it's final sections are formed by straight lines, curved lines or a combination of both, that narrow or sharpen progressively, whose ends form shapes that can be symmetrical or asymmetrical, regular or irregular, organic, hand drawn or accidental and whose diameter, axis, base, height, straight side, perpendicularity, cross section or oblique cut is less than 0.75 mm regarding the width of the toothpick's final section, and the toothpick's final section can extend longitudinally between 0.1 and 20 mm towards the end of the toothpick's final section regarding the toothpick's length, which allows for interdental cleaning in a more efficient way, since the significantly narrow section allows the access between the teeth or molars achieving a deep and effective cleaning of the interproximal space to remove most food debris, unlike the already existing products available in the market.

### FIGURES BRIEF DESCRIPTION

FIG. 1 illustrates a front view and a top view of a toothpick for oral hygiene with three sections: a rectangular triangular section, an irregular quadrilateral (trapezoidal) section, and a curved section.

FIG. 2 illustrates a front view and a top view of a toothpick for oral hygiene with four sections: a rectangular triangular section, a rectangular section, an irregular quadrilateral (trapezoidal) section and a curved section.

FIG. 3a illustrates a front view of a part of the toothpick for oral hygiene with two sections: an irregular quadrilateral section (trapezoidal) with a cross section and a curved section.

FIG. 3b illustrates a front view of a part of the toothpick for oral hygiene with two sections: an irregular quadrilateral section (trapezoidal) with a cross section and a curved section.

FIG. 3c illustrates a front view of a part of the toothpick for oral hygiene with two sections: an irregular quadrilateral section (trapezoidal) with a cross section and a curved section.

FIG. 4a illustrates a front view of a part of the triangular rectangular section with a cross section of a toothpick for oral hygiene with the end of its final section in triangular shape.

FIG. 4b illustrates a front view of a part of the rectangular triangular section with a cross section of a toothpick for oral hygiene with the end of its final section in vertical oval shape.

FIG. 4c illustrates the front view of a part of the triangular rectangular section with a cross section of a toothpick for oral hygiene with the end of its final section in horizontal oval shape.

FIG. 4d illustrates a front view of a part of the rectangular triangular section with a cross section of a toothpick for oral hygiene with the end of its final section in squared shape.

FIG. 4e illustrates a front view of a part of the rectangular triangular section with a cross section of a toothpick for oral hygiene with the end of its final section in hexagonal shape.

FIG. 4f illustrates a front view of a part of the triangular rectangular section with a cross section of a toothpick for oral hygiene with the end of its final section in star shape.

FIG. 4g illustrates a front view of a part of the triangular rectangular section with a cross section of a toothpick for oral hygiene with the end of its final section in circular shape.

FIG. 5 illustrates a front view of the irregular quadrilateral section (trapezoidal) with a cross section, and a curved section of a toothpick for oral hygiene.

### DETAILED DESCRIPTION OF THE INVENTION

The present invention is related to a toothpick for oral hygiene that presents ultra-thin and ultra-narrow dimensions that allows a deep effective and efficient cleaning of the interproximal space to remove most food remains. The toothpick is made up of any type of flexible material, non-toxic, non-brittle or prone to splintering and its geometry is formed by straight lines, curved lines or a combination of both limited to its dimensions (length by width by thickness) which provides flexibility properties, ultra-lightness and ultra-fineness.

The toothpick for oral hygiene consists of a single piece of elongated flexible material with a length that can be chosen, but not limited to, between 40 and 80 mm, preferably 56 mm; a width that can be chosen, but not limited to, from 0.5 to 10 mm, preferably 3 mm, the width can vary along the toothpick; a thickness that can be chosen, but not limited to, between 0.1 and 2 mm, this thickness can vary along the toothpick to provide greater firmness and resistance to bending, or greater flexibility when it is thin.

The final sections of the toothpick are formed by straight lines, curved lines or a combination of both that are gradually narrowing or sharpening, forming the ends of the toothpick. The ends form symmetrical or asymmetrical, regular or irregular, organic, hand drawn or accidental shapes, with a diameter, axis, base, height, straight side, perpendicularity, cross section or oblique cut of less than 0.75 mm regarding the width of the toothpick and the section end of the toothpick can extend between 0.1 and 20 mm towards the end of the final section, regarding the length of the toothpick, allowing interdental cleaning in a more efficient way, since the final section of at least one end is significantly narrow, which allows it to reach between the teeth or molars achieving a deep, efficient and effective cleaning of the interproximal space allowing the removal of most food debris, unlike the existing products on the market.

The vertexes of the triangular, rectangular or quadrilateral (trapezoidal) sections of the toothpick are formed from diagonal cuts at the corners of a rectangular sheet. The diagonal cut is made from one of the corners of the so toothpick to a point on the long side of the rectangle that makes up the sheet, where this larger side is opposite the larger side which is the corner of the sheet where the cut originates, forming a trapezoidal end wherein the apex angle is comprised between 5° and 9°, preferably 9°.

A second alternative for the end of the toothpick is when the sheet has two diagonal cuts in two contiguous corners that are joined by a short side of the rectangle formed by the sheet, so that these two diagonal cuts intersect forming the apex that shapes the tip of the toothpicks, forming a triangular section.

There is a third alternative for the end of the toothpick in which the curved section has a curved or concave shape extended to one side of the toothpick, with a curvature or concavity between 30° and 180°, which allows the user to perform a deep, efficient and effective cleaning of the interproximal space allowing the removal of most food debris.

The toothpick can have at least two sections, these sections can be both triangular, both irregular quadrilaterals (trapezoidal), or an irregular quadrilateral section (trapezoidal) and the other triangular section. In addition, a curved section can replace a section of the toothpick.

The final sections of the toothpick are formed by straight lines, curved lines or a combination of both that are gradually narrowing or sharpening, forming the ends of the toothpick. The ends form symmetrical or asymmetrical, regular or irregular, organic, hand drawn or accidental shapes, with a diameter, axis, base, height, straight side, perpendicularity, cross section or oblique cut less than 0.75 mm regarding the width of such final section of the toothpick, and the final section of the toothpick may extend longitudinally between 0.1 mm and 20 mm towards the end of the final section regarding the length of the toothpick which allows a deep, efficient and effective interdental cleaning in a more efficient way since the final section of at least one of the significantly narrow ends allows it to reach between the teeth or molars achieving a deep, efficient and effective cleaning of the interproximal space allowing the removal of most food debris, unlike the existing products already in the market.

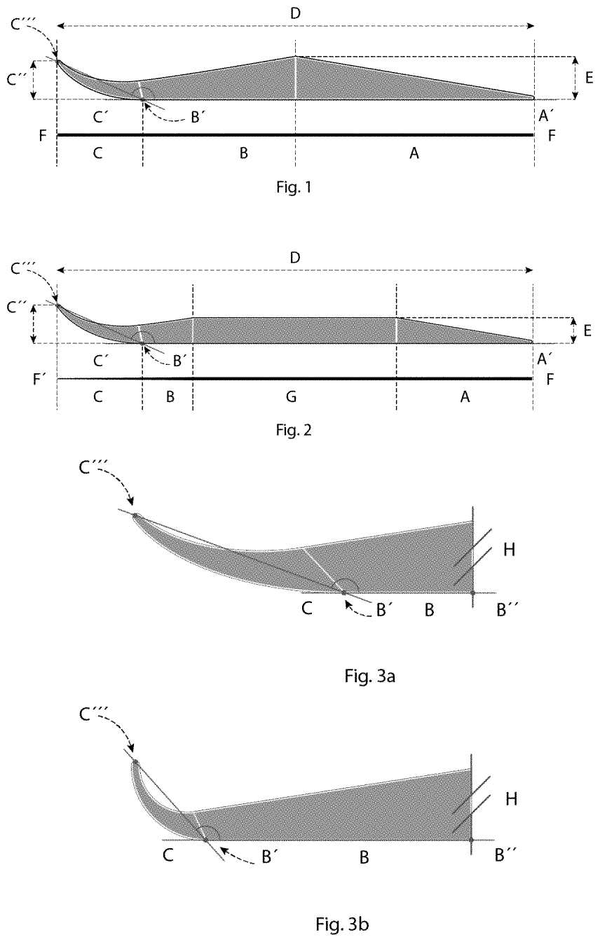

FIG. 1 illustrates a front view of a dental hygiene toothpick with three sections: A rectangular triangular section (A), an irregular quadrilateral section (trapezoidal) (B) and a curved section (C). The toothpick for oral hygiene has a length (D) that can be chosen, but not limited to, between 40 mm and 80 mm, preferably 56 mm, and a width, (E), which can be chosen, but not limited to between 3 mm and 10 mm, preferably 5 mm. The curved section has a length (C′) that can be chosen, but not limited to, between 5% and 35% regarding the length (D) of the toothpick, preferably 20%, a height (C″), which can be chosen, but not limited to, between 80% and 99%, preferably 90% regarding the width (E) of the toothpick, and an angle of curvature which can be chosen, but not limited to, between 30° and 180°, preferably 155°, considering the vertex (B′) which delimits the irregular quadrilateral section (trapezoidal) with the curved section, the point (C′″) at the end of the curve section and the side (A′B′) to identify the measure (C′″B′A′). FIG. 1 also illustrates a top view of a toothpick for oral hygiene with a thickness (F) that can be chosen, but not limited to, between 0.1 mm and 2 mm, preferably 0.35 mm.

FIG. 2 illustrates a front view of a toothpick for oral hygiene with four sections: A rectangular triangular section (A), a rectangular section (G), an irregular quadrilateral section (trapezoidal) (B) and a curved section (C).

The toothpick for oral hygiene has a length (D), which can be chosen, but not limited to, between 40 mm and 80 mm, preferably 56 mm, and a width (E), which can be chosen, but not limited to, between 3 mm and 10 mm, preferably 3 mm. The curved section has a length (C′), which can be chosen, but not limited to, from 5% to 35% with respect to the length (D) so of the toothpick, preferably 20%, a height (C″), which may be chosen, but not limited to, between 80% and 170%, preferably 150%, with respect to the width (E) of the toothpick, and a curvature angle which may be chosen, but not limited to, between 30° and 180°, preferably 155%, considering the vertex (B′) which delimits the irregular quadrilateral section (trapezoidal) with the curved section, the point (C′″) at the end of the curved section and the side (A′B′) to identify the measure (C′″B′A′). FIG. 2 also illustrates a top view of a toothpick for oral hygiene with thickness (F), which can be chosen, but not limited to, between 0.1 mm and 2 mm, preferably 0.35 mm, said thickness varying along the toothpick to a thickness (F′), which may be chosen, but not limited to, between 0.1 mm and 2 mm, preferably 0.1 mm.

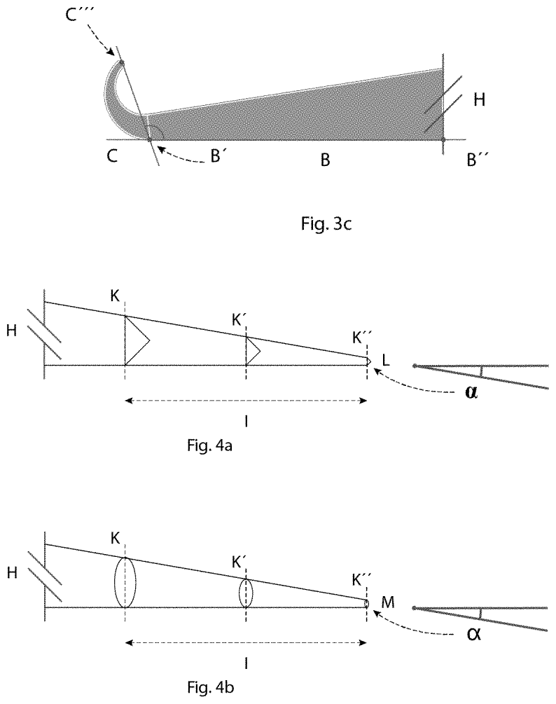

FIG. 3a illustrates a front view of a part of the toothpick for oral hygiene with two sections: an irregular quadrilateral section (trapezoidal) (B), with a cross section (H), and a curved section (C). The bend angle of the curved section can be chosen, but not limited to, between 30° and 180°, preferably 160°, considering the vertex (B′) that delimits the irregular quadrilateral (trapezoidal) section (B) with the curved section (C), the point (C′″) at the end of the curved section and side (B′B″) to identify measure (C′″B′B″).

FIG. 3b illustrates a front view of a part of the toothpick for oral hygiene with two sections: an irregular quadrilateral section (trapezoidal) (B), with a cross section (H), and a curved section (C). The bend angle of the curved section can be chosen, but not limited to, between 30° and 180°, preferably, 132°, considering the vertex (B′) that delimits the irregular quadrilateral (trapezoidal) section (B) with the curved section (C), a point (C′″) at the end of the curved section and a side (B′B″) to identify the measure (C′″B′B″).

FIG. 3c illustrates a front view of a part of the toothpick for oral hygiene with two sections: an irregular quadrilateral section (trapezoidal) (B), with a cross section (H), and a curved section (C). The bend angle of the curved section can be chosen, but not limited to, between 30° and 180°, preferably, 110°, considering the vertex (B′) that delimits the irregular quadrilateral (trapezoidal) section (B) with the curved section (C), a point (C′″) at the end of the curved section and a side (B′ B″) to identify the measure (C′″B′B″).

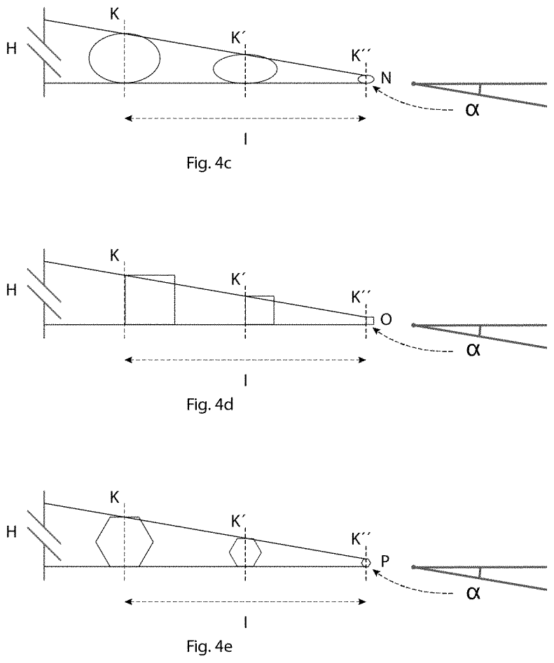

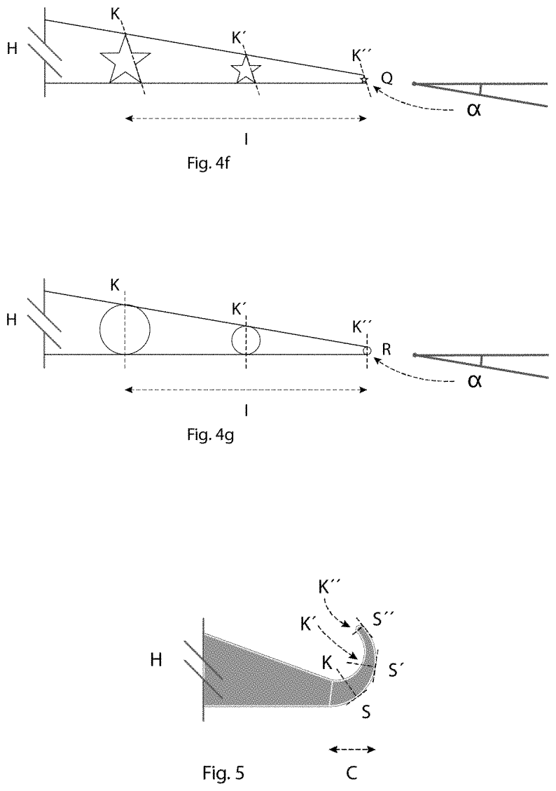

FIG. 4a illustrates a front view of a part of the rectangular triangular section (H) of a toothpick for oral hygiene, with the end of its final section in triangular shape (L). The final section of the toothpick (I) is formed by straight lines that narrow or sharpen progressively until obtaining a base (K) of the triangular end, equivalent to 0.75 mm regarding the width of this final section of the toothpick, being able to narrow until obtaining a base (K′) equivalent to 0.375 mm regarding the width of this final section of the toothpick, being able to narrow a base (K″) of the end in triangular form equivalent of 0.05 mm regarding the width of this final section of the toothpick. The final section of the toothpick (I) can extend longitudinally between 0.1 mm and 20 mm towards the end of the final section regarding the length of the toothpick taking as reference the base (K) of the imaginary triangle towards the end in triangular shape towards the triangular shaped end (L) or, forming an angle (α) at the end of the final section that can go between 5° and 9°, preferably 9°.

FIG. 4b illustrates a front view of a part of the rectangular triangular section (H) of a toothpick for oral hygiene, with the end of its final section in vertical oval shape (M). The final section of the toothpick (I) is formed by straight lines that are gradually narrowing or sharpening to obtain a major axis (K) of the vertical oval end equivalent to 0.75 mm regarding the width of said final section of the toothpick, narrowing to obtain a major axis (K′) of the end in vertical oval shape equivalent to 0.375 mm regarding the width of this final section of the toothpick, narrowing until obtaining a major axis (K″) of the vertical oval end equivalent to 0.05 mm regarding the width of this final section of the toothpick. The final section of the toothpick (I) can extend lengthwise between 0.1 mm and 20 mm towards the end of the final section regarding the length of the toothpick taking as reference the major axis (K) of the imaginary vertical oval shape towards the vertical oval shaped end (M), or forming an angle (α) at the end of the final section that can go between 5° and 9°, preferably 9°.

FIG. 4c illustrates a front view of a part of the rectangular triangular section (H) of a toothpick for oral hygiene, with the end of its final section in horizontal oval shape (N). The final section of the toothpick (I) is formed by straight lines that are gradually narrowing or sharpening to obtain a smaller axis (K) of the horizontal oval end equivalent to 0.75 mm regarding the width of this final section of the toothpick, narrowing to obtain a smaller axis (K′) of the end in horizontal oval shape equivalent to 0.375 mm regarding the width of this final section of the toothpick, narrowing until obtaining a smaller axis (K″) of the horizontal oval end equivalent to 0.05 mm regarding the width of this final section of the toothpick. The final section of the toothpick (I) can extend lengthwise between 0.1 mm and 20 mm towards the end of the final section regarding the length of the toothpick taking as reference the smaller axis (K) of the imaginary horizontal oval shape towards the horizontal oval shaped end (M), or forming an angle (a) at the end of the final section that can go between 5° and 9°, preferably 9°.

FIG. 4d illustrates a front view of a part of the rectangular triangular section (H) of a toothpick for oral hygiene, with the end of its final section in square shape (O). The final section of the toothpick (I) is formed by straight lines that are gradually narrowing or sharpening to obtain a height (K) of the square end equivalent to 0.75 mm regarding the width of this final section of the toothpick, narrowing to obtain a height (K′) of the end in square shape equivalent to 0.375 mm regarding the width of this final section of the toothpick, narrowing until obtaining a height (K″) of the square end equivalent to 0.05 mm regarding the width of this final section of the toothpick. The final section of the toothpick (I) can extend lengthwise between 0.1 mm and 20 mm towards the end of the final section regarding the length of the toothpick taking as reference the height (K) of the imaginary square shape towards the square shaped end (O), or forming an angle (a) at the end of the final section that can go between 5° and 9°, preferably 9°.

FIG. 4e illustrates a front view of a part of the rectangular triangular section (H) of a toothpick for oral hygiene, with the end of its final section in hexagonal shape (P). The final section of the toothpick (I) is formed by straight lines that are gradually narrowing or sharpening to obtain a height (double of the apothem) (K) of the hexagonal shape end equivalent to 0.75 mm regarding the width of this final section of the toothpick, narrowing to obtain a height (double of the apothem) (K′) of the end in hexagonal shape equivalent to 0.375 mm regarding the width of this final section of the toothpick, narrowing until obtaining a height (double of the apothem) (K″) of the hexagonal end equivalent to 0.05 mm regarding the width of this final section of the toothpick. The final section of the toothpick (I) can extend lengthwise between 0.1 mm and 20 mm towards the end of the final section regarding the length of the toothpick taking as reference the height (double of the apothem) (K) of the imaginary hexagonal shape towards the hexagonal shaped end (P), or forming an angle (α) at the end of the final section that can go between 5° and 9°, preferably 9°.

FIG. 4f illustrates a front view of a part of the rectangular triangular section (H) of a toothpick for oral hygiene, with the end of its final section in star shape (Q). The final section of the toothpick (I) is formed by straight lines that are gradually narrowing or sharpening to obtain an oblique cut (K) of the star shaped end equivalent to 0.75 mm regarding the width of this final section of the toothpick, narrowing to obtain an oblique cut (K′) of the end in star shape equivalent to 0.375 mm regarding the width of this final section of the toothpick, narrowing until obtaining an oblique cut (K″) of the star shaped end equivalent to 0.05 mm regarding the width of this final section of the toothpick. The final section of the toothpick (I) can extend lengthwise between 0.1 mm and 20 mm towards the end of the final section regarding the length of the toothpick taking as reference the oblique cut (K) of the imaginary star shape towards the star shaped end (Q), or forming an angle (a) at the end of the final section that can go between 5° and 9°, preferably 9°.

FIG. 4g illustrates a front view of a part of the rectangular triangular section (H) of a toothpick for oral hygiene, with the end of its final section in circular shape (R). The final section of the toothpick (I) is formed by straight lines that are gradually narrowing or sharpening to obtain a diameter (K) of the circular shape end equivalent to 0.75 mm regarding the width of this final section of the toothpick, narrowing to obtain a diameter (K′) of the end in circular shape equivalent to 0.375 mm regarding the width of this final section of the toothpick, narrowing until obtaining a diameter (K″) of the circular end equivalent to 0.05 mm regarding the width of this final section of the toothpick. The final section of the toothpick (I) can extend lengthwise between 0.1 mm and 20 mm towards the end of the final section regarding the length of the toothpick taking as reference the diameter (K) of the imaginary circular shape towards the circular shaped end (R), or forming an angle (a) at the end of the final section that can go between 5° and 9°, preferably 9°.

FIG. 5 illustrates a view of an irregular quadrilateral section (trapezoidal) with a cross section (H) and a curved section of a toothpick for oral hygiene. The curved section of the toothpick (C) is formed by curved lines that narrow it or sharpen it progressively until obtaining a perpendicularity of a cross section (K) with respect to a tangential line (S) equivalent to 0.75 mm regarding the width of this final section of the toothpick, narrowing until obtaining a perpendicularity of a cross section (K′) regarding a tangential line (S) equivalent to 0.05 mm regarding the width of this final section of the toothpick.

The advantages of the present invention are:
To attain tips with small enough dimensions without burrs or splinters.
By having a flat and flexible toothpick with a thickness of 2 mm or less, end sections of 20 mm long or less, and these final sections with 0.75 mm wide or less, a deep, efficient and effective cleaning of the interproximal space is achieved, allowing the removal of most food debris.
Because it is a toothpick with a tip as thin as some dental floss, and with longer and narrower tips than other toothpicks, it manages to reach between the teeth and molars in the vestibular area (outside or cheek) to the palatal area or lingual area, achieving greater cleanliness than traditional toothpicks or similar products.
Thick and firm tips allow superficial cleaning or reaching between orthodontic appliances to remove hard particles from the teeth.
The thin and flexible tips allow the use between orthodontic appliances in a more comfortable way, in addition to reaching deeper areas between teeth and molars without generating the risk of causing a diastema (excessive separation of the teeth).
The curved (concave or convex) sections allow a more comfortable, deep, efficient and effective cleaning of the interproximal space to remove most food debris.
Rounded micro tips avoid hurting or lacerating the gums allowing cleaning in smaller or narrow spaces in a more secure way.
Greater deep interproximal cleaning, safe, comfortable, reliable, efficient and effective.

The invention has been well enough described so that a person with average knowledge in the field can reproduce and obtain the results described in the present invention. However, any person skilled in this invention's techniques may be able to make modifications not described in the present application, however, if for the application of these modifications in a particular product or in the manufacturing process of the same are required of the subject matter claimed in the following claims, these structures should be included within the scope of the invention.

1- A toothpick for oral hygiene formed by a single piece of elongated flexible material whose geometry delimits it dimensionally (length by width by thickness), straight lines, curves or a combination of both that are gradually narrowing or sharpening forming one or more ends of the toothpicks, characterized by the fact that the end(s) of the final sections form symmetrical or asymmetrical, regular, irregular, organic, hand drawn or accidental shapes with a diameter, axis, base, height, straight side, perpendicularity, cross section or oblique cut less than 0.75 mm regarding the width of this final section of the toothpick; the final section of the toothpick can be extended longitudinally between 0.1 and 20 mm towards the end of the final section regarding the length of the toothpick, or alternatively, form an angle at the end of the final section which can range from 5° to 9°; and the width and thickness of the toothpick can vary between 0.5 and 10 mm and 0.1 and 2 mm respectively along the toothpick.

2- The toothpick for oral hygiene as claimed in claim 1, further characterized by the fact that the final section includes a diameter, axis, base, height, straight side, perpendicularity, cross section or oblique cut less than 0.75 mm regarding the width of this final section of the toothpick, which allows it to reach between the teeth or molars achieving a deep, efficient and effective cleaning of the interproximal space to remove most food remains.

3- The toothpick for oral hygiene as claimed in claim 2, is further characterized by its flexibility, ultra lightness and ultra fineness.

4- The toothpick for oral hygiene as claimed in claim 1, further characterized in the fact that the length of the toothpick can be chosen between 40 and 80 mm.

5- The toothpick for oral hygiene as claimed in claim 1, further characterized in the fact that one or more end sections can be curved with a bend angle that can be chosen between 30° and 180° considering the vertex that defines the section contiguous with this curved section and the end of the curved section.

6- The toothpick for oral hygiene as claimed in claim 1, further characterized in the fact that the thickness of the toothpick can be chosen up to 2 mm, which allows removing hard particles from the teeth.
